(19) United States
(12) Patent Application Publication
(10) Pub. No.: US 2020/0096980 A1
(43) Pub. Date: Mar. 26, 2020

(54) SCADA OPERATOR DECISION SUPPORT USING INTEGRATED ENGINEERING AND OPERATIONAL DATA SERVER SYSTEM AND METHOD

(71) Applicant: AVEVA Software, LLC, Lake Forest, CA (US)

(72) Inventors: Douglas Kane, Lake Forest, CA (US); Mats Westenius, Lund (SE); John Joseph Krajewski, Rancho Santa Margarita, CA (US); Julien de Beer, Noisy-le-Grand (FR); Colm McCarthy, Cambridge (GB); Steven Michael Weinrich, York, PA (US); Derrick Jones, Irvine, CA (US); Simon Foley, Cambridgeshire (GB); Paul Burton, Cambridgeshire (GB)

(21) Appl. No.: 16/560,780

(22) Filed: Sep. 4, 2019

Related U.S. Application Data
(60) Provisional application No. 62/726,790, filed on Sep. 4, 2018.

(51) Int. Cl. G05B 19/418; G06F 3/0481; G06F 3/0484

(52) U.S. Cl. CPC G05B 19/41885; G06F 3/04815; G06F 3/04847; G06F 2203/04806; G05B 2219/23258; G05B 2219/24103; G05B 2219/25067; G05B 2219/23182

(57) ABSTRACT

Embodiments of the invention include a system and method capable of generating an operations management interface enabling monitoring of distributed components of a process control application. The operations management interface can include a customizable display enabling operators to prepare decisions based on a context-based three-dimensional representation of the distributed components. The operations management interface display includes controls for manipulating graphically displayed representations of data rendered by the distributed components, and an interface for exchanging requests and data through data links to one or more distributed data-linked components. Some selectable displayed information in the operations management interface window can include locations, interconnection layout and hierarchy, and specifications, and datasheets of distributed components.

### RELATED APPLICATIONS

This application claims the benefit of and priority to U.S. Provisional Application No. 62/726,790, filed Sep. 4, 2018, entitled “SCADA OPERATOR DECISION SUPPORT USING INTEGRATED ENGINEERING AND OPERATIONAL DATA SYSTEM AND METHOD”, the entire contents of which are incorporated herein by reference.

### BACKGROUND

Industrial plant operators need a great deal of information about assets beyond the current process variables from a real-time monitoring system to make appropriate operational decisions. In most instances, plant operators utilize multiple software applications and manual exploration to attempt to have access to helpful data. Operators need context-based information to make appropriate decisions in many circumstances. That information can include (1) what physical equipment is located in a facility, along with details of the equipment's location; (2) what is connected to the equipment in question; and (3) additional specification information about the equipment. Some of this information is traditionally available through multiple independent applications.

Thus, there exists a need in the industry to integrate operational and engineering data into a common, live or real-time contextualized user interface, where an improved decision support capability integrates an engineering information management system and operator interface within an operations management interface that is capable of enhancing the type of information presented to the operator, and the speed at which it is presented.

### SUMMARY

Some embodiments include a server system comprising at least one processor configured to be coupled to a non-transitory computer-readable storage medium, and tangibly storing thereon a program logic for execution by the at least one processor. In some embodiments, the program logic comprises at least one logic module executable by the at least one processor to manage a bi-directional exchange of context-driven data between application objects of the program logic and one or more distributed assets of a distributed environment. Some embodiments include at least one display controller coupled to the at least one logic module. In some embodiments, the at least one display controller is configured to render at least one operations management interface on at least one user display. In some embodiments, the at least one operations management interface is configured to display at least one distributed asset of a distributed environment with at least one attribute of the at least one distributed asset. Some further embodiments include at least one navigation module executable by the at least one processor configured for varying a displayed context of at least one virtual representation of at least a portion of the at least one distributed asset based at least in part on at least one of input from at least one user, and at least a portion of the context-driven data.

In some embodiments, the one or more distributed assets include one or more distributed components of a process control and/or manufacturing information system of the distributed environment. In some embodiments, the at least one display controller includes controls for graphically manipulating displays of virtual representations of at least one or more distributed components of the at least one distributed asset. In some embodiments, the displayed context of at least one of the one or more distributed components is altered based at least in part on at least one user selection of at least one distributed asset, and a context relationship of at least one component of the at least one distributed asset in relation to at least one other component of the at least one distributed asset.

In some embodiments, the displayed context corresponds to the at least one attribute of at least one distributed component. In some embodiments, the at least one attribute includes an operational status of at least one component of the at least one distributed asset. In some embodiments, the at least one attribute includes an alarm status of at least one component of the at least one distributed asset. In some further embodiments, the at least one attribute includes data derived from a maintenance record, an equipment data specification, a drawings and piping and instrumentation diagram, and/or a standard operating procedure of at least one component of the at least one distributed asset.

In some embodiments, the at least one operations management interface is further configured to display a substantially real-time visualization of operational data of at least one component of the at least one distributed asset. In some further embodiments, the at least one navigation module is executable by the at least one processor to enable the at least one user to navigate either an operational model or an engineering model, where the display adjusts automatically to a changing context of at least one asset of the one or more distributed assets, and displays appropriate contextual information.

In some embodiments, the at least one operations management interface is further configured to display at least one process graphic associated with one or more alarms related to at least one component of the at least one distributed asset.

In some further embodiments, the at least one virtual representation of at least a portion of the at least one distributed asset includes one or more 3D models of at least a portion of an industrial facility of process.

In some further embodiments, the at least one navigation module executable by the at least one processor is configured to enable the at least one user to zoom-in to one or more 3D models, and display selectable drawings and piping and instrumentation diagram context or data sheets related to a visualized asset.

In some embodiments, the at least one navigation module is configured to dynamically react to context change during any zoom-in or zoom-out commands or actions, and is further configured to show appropriate process graphics and/or alarms based at least in part on an updated context of the at least one virtual representation.

Some embodiments include a server system comprising program logic tangibly stored on at least one non-transitory computer-readable storage medium, and at least one processor coupled to the non-transitory computer-readable storage medium. In some embodiments, upon execution of at least a portion of the program logic by the at least one processor, the at least one processor is configured to process a method including operating at least one display controller configured to render at least one operations management interface on at least one user display. In some embodiments, the at least one operations management interface configured to display at least one distributed asset of a distributed environment including a display of at least one attribute of the at least one distributed asset.

Some embodiments include operating at least one navigation module executable by the at least one processor for varying a displayed context of the at least one virtual representation of at least a portion of the at least one distributed asset.

Some further embodiments include displaying controls for graphically manipulating at least a portion of the at least one virtual representation, where a displayed context of at least one component of the one or more distributed assets is dynamically variable based at least in part on at least one user selection of at least one distributed asset, and a context relationship of the at least one component of the at least one distributed asset in relation to at least one other component of the at least one distributed asset.

In some embodiments, at least a portion of the program logic includes a mapping component configured to be executed by the at least one processor to display map components and location data of the at least one distributed asset.

### DESCRIPTION OF THE DRAWINGS

FIG. 1 illustrates a non-limiting example of a display GUI produced by one or more embodiments of the invention.

FIG. 2 illustrates an integration architecture in accordance with some embodiments of the invention.

FIG. 3 illustrates an integration architecture in accordance with some further embodiments of the invention.

FIG. 4 illustrates a computer system enabling or comprising the integration architecture of FIG. 2 and/or FIG. 3 in accordance with some embodiments of the invention.

FIGS. 5A-5C illustrates a non-limiting example of information models produced by one or more embodiments of the invention.

FIGS. 6A-6C illustrates a non-limiting example of logic and/or layout diagrams produced by one or more embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Embodiments of the invention herein generally describe non-conventional approaches to systems and methods to data processing and management that are not well-known, and further, are not taught or suggested by any known conventional methods or systems. Moreover, the specific functional features are a significant technological improvement over conventional methods and systems, including at least the operation and functioning of a computing system that are technological improvements. These technological improvements include one or more aspects of the systems and methods described herein that describe the specifics of how a machine operates, which the Federal Circuit makes clear is the essence of statutory subject matter.

One or more of the embodiments described herein include functional limitations that cooperate in an ordered combination to transform the operation of a data repository in a way that improves the problem of data storage and updating of databases that previously existed. In particular, some embodiments described herein include system and methods for managing single or multiple content data items across disparate sources or applications that create a problem for users of such systems and services, and where maintaining reliable control over distributed information is difficult or impossible.

The description herein further describes some embodiments that provide novel features that improve the performance of communication and software, systems and servers by providing automated functionality that effectively and more efficiently manages resources and asset data for a user in a way that cannot effectively be done manually. Therefore, the person of ordinary skill can easily recognize that these functions provide the automated functionality, as described herein, in a manner that is not well-known, and certainly not conventional. As such, the embodiments of the invention described herein are not directed to an abstract idea and further provide significantly more tangible innovation. Moreover, the functionalities described herein were not imaginable in previously-existing computing systems, and did not exist until some embodiments of the invention solved the technical problem described earlier.

Some embodiments of the invention include integration of data from distributed assets in a distributed environment for context-driven display of 3D models, equipment data specifications, maintenance records, related events, and/or drawings and piping and instrumentation diagrams (“P&IDs”) integrated into a supervisory control and data acquisition (hereinafter “SCADA”) operator interface. In some embodiments, the SCADA operator interface can present information to an operator or user about the state of a process such as one or more distributed assets including one or more distributed components of a process control and/or manufacturing information system of the aforementioned distributed environment. In some embodiments, the SCADA operator interface can function as a human-machine interface (“HMI) enabling intake and processing of an operators control instructions. In some embodiments, at least a portion of the SCADA can comprise at least one program module including program logic tangibly stored on at least one non-transitory computer-readable storage medium of the system that includes at least one processor coupled to the non-transitory computer-readable storage medium for processing one or more logic codes of the program logic to perform one or methods of the invention.

Some embodiments of the invention include an engineering information management system (“Application NET”) that is integrated into an operator interface such as an “InTouch” operations management interface (OMI) that automatically presents content-based and/or context-based asset information to operators (also known as users). In some embodiments, the OMI can be configured to display a 3D representation of where one or more assets (e.g., such as equipment) exist in context to other equipment. Further, in some embodiments, the OMI can be configured to provide specific data specifications of the equipment, and traditional SCADA real-time visualizations of operational data. In some embodiments, at least a portion of the Application NET can comprise at least one further program module including program logic tangibly stored on at least one non-transitory computer-readable storage medium of the system that includes at least one processor coupled to the non-transitory computer-readable storage medium for processing one or more logic codes of the program logic to perform one or methods of the invention.

In some embodiments of the invention, the system can enable the user/operator to navigate either the operational model (within the SCADA system) or the engineering model (within Application NET), or both, where the display adjusts automatically to the changing context and shows the user appropriate contextual information. For example, in one embodiment, a navigation module executable by a processor can vary a displayed context of a virtual representation of a distributed asset. In some embodiments, such a system can display controls for graphically manipulating a virtual representation of an asset, where the displayed context of a component of an asset can be dynamically variable based on user selection and/or a context relationship of one component versus another component.

Some embodiments of the invention described herein can assist in reducing system or equipment downtime, and can increase efficiency through the automated reuse of engineering information available in Application NET such as 3D models, drawings and piping and instrumentation diagrams, maintenance records, standard operating procedures, vendor documents, etc.

Some embodiments of the invention described herein can increase operator efficiency and situational awareness by responding to, as well as driving, context changes in the operations management interface applications.

Some embodiments of the invention described herein can secure improved item identification in information exchange between the operator and maintenance engineers as different naming conventions between the operations and engineering models are bridged.

In some embodiments, when an operator selects an item in one of the operations applications (e.g. in response to a condition such as an alarm), the item's context, including the name and path of the selected item, can be propagated to all applications in the runtime OMI framework including the Application NET application.

In some embodiments, as an item often is named differently in the process model (e.g., in an “InTouch” OMI) and in the engineering model (e.g., an Application NET), embodiments of the invention can leverage the name alias and look-up features of InTouch OMI and Application NET to find the corresponding engineering item in both InTouch OMI and Application NET.

In some embodiments, the Application NET OMI application can display the engineering name of the item, its 3D representation in the context of the plant, configured engineering attributes, 2D diagrams, and other referenced documents.

In some embodiments, the operator can also navigate engineering 3D model or 2D diagrams (e.g. to investigate the possible root cause of the condition). In some embodiments, the OMI framework context and thus other applications can be updated to display the appropriate data accordingly.

Some embodiments of the invention include an OMI that provides an interface to create operator interfaces which react to context changes showing the user the correct information needed to make decisions, and providing navigation through data for rapid problem solving without leaving the application.

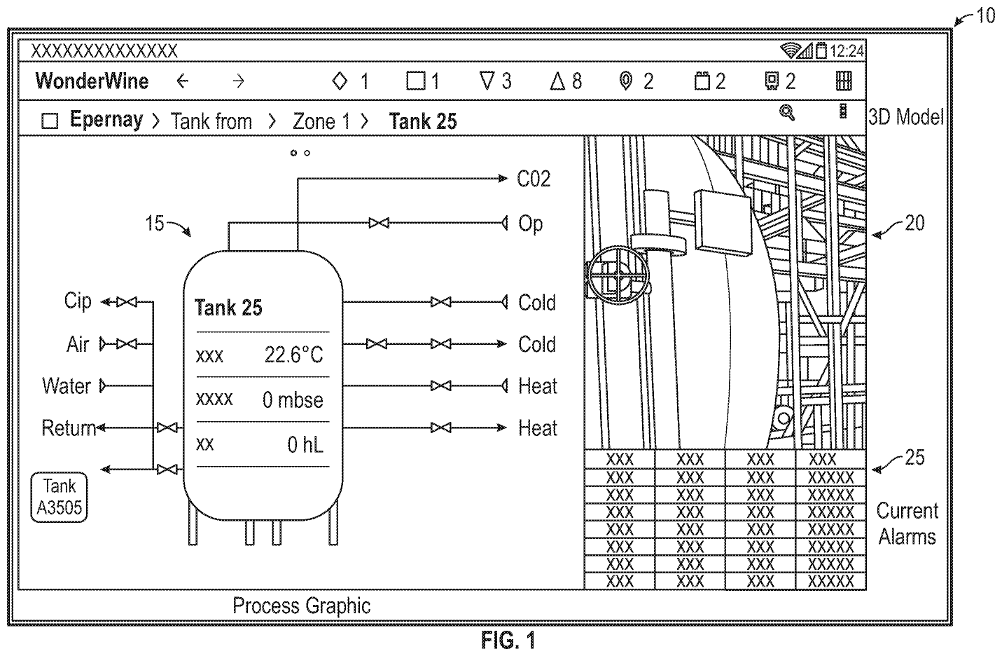

In some embodiments, an alarm-driven context can be a simulated application alarm condition. In some embodiments, an operator can select an alarm in an alarm application. In some further embodiments, an OMI can vary in context to equipment associated with the alarm. Referring to FIG. 1, showing a non-limiting example of a display GUI 10, in some embodiments of the invention, the OMI can present process graphics associated with the alarm to the operator, and/or one or more rendered 3D models of the plant, where the system provides an ability to zoom-in to one or more areas of the plant and/or to individual equipment) and to focus on the particular asset/tag, and/or a drawings and piping and instrumentation diagram context or data sheet (optionally if configured). For example, in some embodiments, the display GUI 10 can include at least one 3D model 20 and/or at least one associated drawings and piping and instrumentation diagram 15. Further, in some embodiments, the display GUI 10 can include at least one alarm display 25 listing one or more active and/or past alarms related to any asset or any component of an asset, including, but not limited to, any asset or any component of an asset represented in the drawings and piping and instrumentation diagram 15 and/or the 3D model 20.

In some embodiments of the invention, the system can enable a user to zoom-in or magnify at least a portion of a displayed 3D model 20 to view or identify an asset or tag. In some embodiments, the operator can navigate in the 3D model 20, and the operator can be enabled to select assets or tags (equipment) in the 3D view of the display GUI 10, where the asset context changes. In this instance, the OMI application can dynamically react to the context change, and can show appropriate process graphics and/or alarm display 25 based on the updated context. Some embodiments enable bidirectional context exchange through the GUI and/or application program interface.

In some embodiments of the invention, as an operator navigates through an OMI application, the OMI can present updated screens showing process graphics of selected navigation items, and/or the alarm display 25 as a selected navigation item, and/or a 3D model 20 focused on asset/tag, and/or additional asset information such as selected attributes, documents (drawings and piping and instrumentation diagrams, datasheets, etc.), and/or OMI map application focused on an asset.

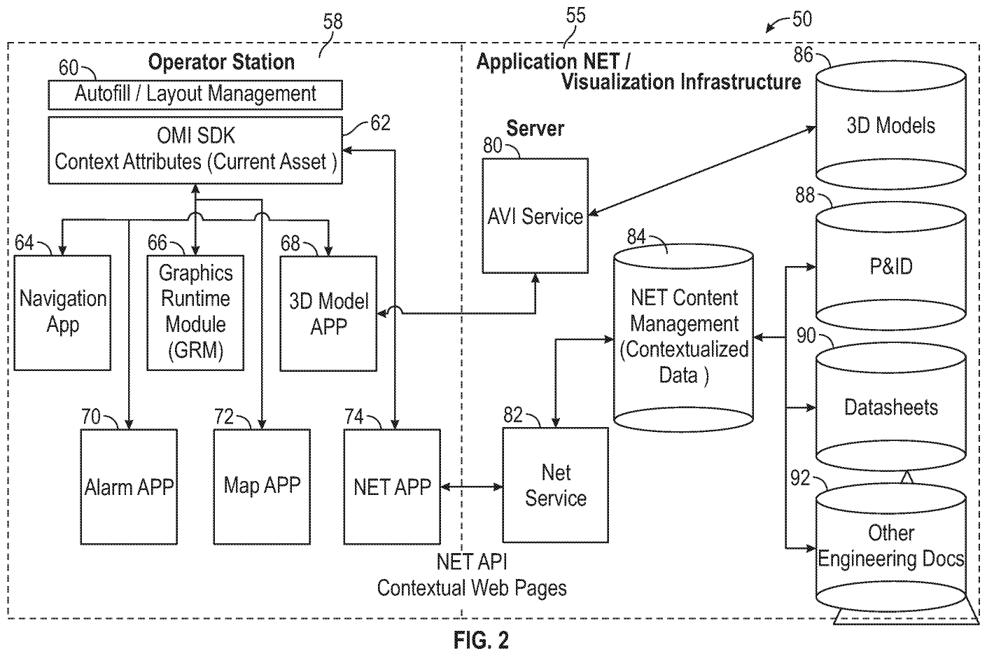

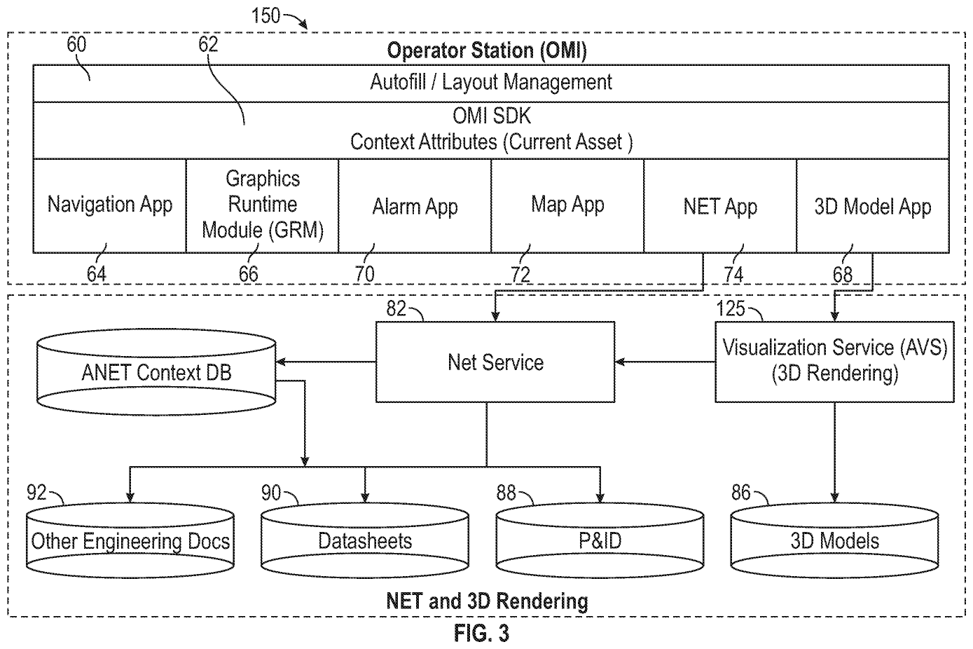

Some embodiments comprise and/or utilize one or more computer systems and applications processed by the one or more computer systems. For example, FIG. 2 illustrates a non-limiting embodiment of an integration architecture 50 in accordance with some embodiments of the invention, and FIG. 3 illustrates another non-limiting embodiment of an integration architecture 150 in accordance with some further embodiments of the invention. In some embodiments, one or more operations or functions can be run and/or hosted on an operator station 58 including, but not limited to, autofill and/or layout management functions and systems 60, and a plurality of program modules coupled to an operations management interface 62 (referred to earlier as “OMI”). In some embodiments, the autofill and/or layout management functions and systems 60 can determine what content to show based on context.

Some embodiments include a navigation application 64 for enabling navigation functions. Some further embodiments include a graphics runtime module 66 for enabling rendering of virtual objects. Some other embodiments include a 3D model application 68 for rendering three-dimensional objects. In some embodiments, an alarm application 70 can enable display of alarm conditions. Some further embodiments include a mapping application 68 enabling display of map components and location data. Some embodiments include a NET application 74 enabling display of contextual web pages. Some embodiments include a bi-directional context exchange managed through an application program interface.

Some embodiments include an Application NET data system 55 integrated into or with the operations management interface 62 using one or more coupled servers including, but not limited to, an “AVI Service” 80 and/or a “Net Service” 82 coupled to one or more databases, including, but not limited to, content management data 84, a 3D model database 86, drawings and piping and instrumentation diagrams 88, datasheets 90, and other engineering documents 92. Referring to FIG. 2, in some embodiments, a visualization service 125 can be used for 3D rendering operations.

Some embodiments of the invention can utilize SWS/IED datasets and 3D model 20 visualizations using one or more applicants hosted on an on-premises computer. Some embodiments can utilize computer systems supporting two independent streams. Some embodiments can utilize Windows® 10, and Intel® Xeon W-2123 3.6 Ghz/i7-8700, 32 GB Ram, Nvidia GTX 1080 or Quadro P5000 (needs to support multiple NVENC streams), 512 GB SSD, supporting X additional independent streams, with two streams per box as specified above. Microsoft®, and Windows®, and the Windows logo are registered trademarks of Microsoft Corporation in the United States and/or other countries. Intel® and the Intel® logo are trademarks of Intel Corporation.

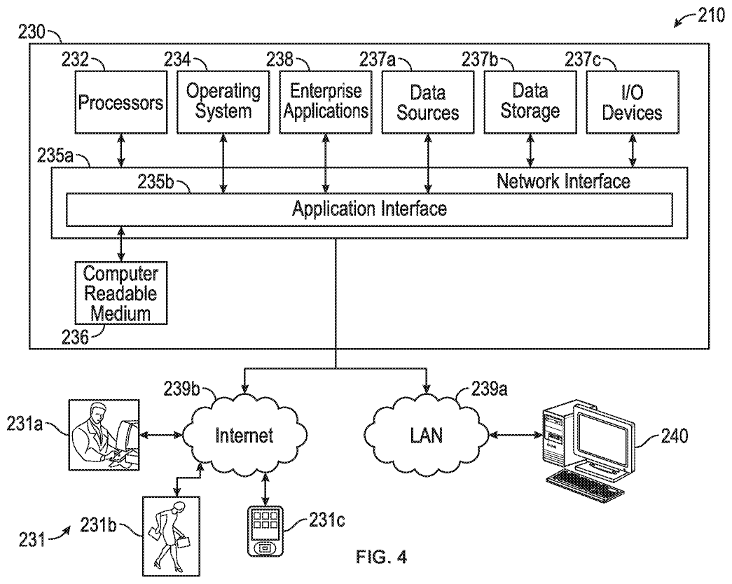

FIG. 4 illustrates a computer system 210 enabling or comprising the integration architecture of FIGS. 2 and/or 3 in accordance with some embodiments of the invention. In some embodiments, the computer system 210 can operate and/or process computer-executable code of one or more software modules of the aforementioned system. Further, in some embodiments, the computer system 210 can operate and/or display information within one or more graphical user interfaces such as the GUI of FIG. 1. In some embodiments, the system 210 can comprise at least one computing device including at least one processor 232. In some embodiments, the at least one processor 232 can include a processor residing in, or coupled to, one or more server platforms. In some embodiments, the system 210 can include a network interface 235a and an application interface 235b coupled to the least one processor 232 capable of processing at least one operating system 234. Further, in some embodiments, the interfaces 235a, 235b coupled to at least one processor 232 can be configured to process one or more of the software modules 238 (e.g., such as one or more enterprise applications). In some embodiments, the software modules 238 can include server-based software, and can operate to host at least one user account and/or at least one client account, and operating to transfer data between one or more of these accounts using the at least one processor 232.

With the above embodiments in mind, it should be understood that the invention can employ various computer-implemented operations involving data stored in computer systems. Moreover, the above-described databases and models described throughout can store analytical models and other data on computer-readable storage media within the system 210 and on computer-readable storage media coupled to the system 210. In addition, the above-described applications of the system can be stored on computer-readable storage media within the system 210 and on computer-readable storage media coupled to the system 210. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated. In some embodiments of the invention, the system 210 can comprise at least one computer readable medium 236 coupled to at least one data source 237a, and/or at least one data storage device 237b, and/or at least one input/output device 237c. In some embodiments, the invention can be embodied as computer readable code on a computer readable medium 236. In some embodiments, the computer readable medium 236 can be any data storage device that can store data, which can thereafter be read by a computer system (such as the system 210). In some embodiments, the computer readable medium 236 can be any physical or material medium that can be used to tangibly store the desired information or data or instructions and which can be accessed by a computer or processor 232. In some embodiments, the computer readable medium 236 can include hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 236 can transmit or carry instructions to a computer 240 and/or at least one user 231, including a router, private or public network, or other transmission device or channel, both wired and wireless. In some embodiments, the software modules 238 can be configured to send and receive data from a database (e.g., from a computer readable medium 236 including data sources 237a and data storage 237b that can comprise a database), and data can be received by the software modules 238 from at least one other source. In some embodiments, at least one of the software modules 238 can be configured within the system to output data to at least one user 231 via at least one graphical user interface rendered on at least one digital display.

In some embodiments of the invention, the computer readable medium 236 can be distributed over a conventional computer network via the network interface 235a where the system embodied by the computer readable code can be stored and executed in a distributed fashion. For example, in some embodiments, one or more components of the system 210 can be coupled to send and/or receive data through a local area network (“LAN”) 239a and/or an internet coupled network 239b (e.g., such as a wireless internet). In some further embodiments, the networks 239a, 239b can include wide area networks (“WAN”), direct connections (e.g., through a universal serial bus port), or other forms of computer-readable media 236, or any combination thereof.

In some embodiments, components of the networks 239a, 239b can include any number of user devices such as personal computers including for example desktop computers, and/or laptop computers, or any fixed, generally non-mobile internet appliances coupled through the LAN 239a. For example, some embodiments include at least one computer 240 coupled through the LAN 239a that can be configured for any type of user including an administrator. Other embodiments can include personal computers coupled through network 239b. In some further embodiments, one or more components of the system 210 can be coupled to send or receive data through an internet network (e.g., such as network 239b). For example, some embodiments include at least one user 231 coupled wirelessly and accessing one or more software modules of the system including at least one enterprise application 238 via an input and output (“I/O”) device 237c. In some other embodiments, the system 210 can enable at least one user 231 to be coupled to access enterprise applications 238 via an I/O device 237c through LAN 239a. In some embodiments, the user 231 can comprise a user 231a coupled to the system 210 using a desktop computer, and/or laptop computers, or any fixed, generally non-mobile internet appliances coupled through the internet 239b. In some further embodiments, the user 231 can comprise a mobile user 231b coupled to the system 210. In some embodiments, the user 231b can use any mobile computing device 231c to wireless coupled to the system 210, including, but not limited to, personal digital assistants, and/or cellular phones, mobile phones, or smart phones, and/or pagers, and/or digital tablets, and/or fixed or mobile internet appliances.

For the purposes of this disclosure the term “server” should be understood to refer to a service point which provides processing, database, and communication facilities. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as a Microsoft® Windows® Server, Mac OS X, Unix, Linux, and/or any other conventional operating system.

For the purposes of this disclosure a “network” should be understood to refer to a network that may couple devices so that communications may be exchanged, such as between a server and a client device, peer to peer communications, or other types of devices, including between wireless devices coupled via a wireless network, for example. A network may also include mass storage, such as network attached storage (NAS), a storage area network (SAN), or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, “Integrated Services Digital Networks” (ISDNs), “Digital Subscriber Lines” (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple user or client devices with a network. A wireless network may employ stand-alone ad-hoc networks, mesh networks, wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including “Long Term Evolution” (LTE), WLAN, wireless router (WR) mesh, or 2nd, 3rd, 4th, or 5th generation (2G, 3G, 4G, or 5G) cellular technology, or the like. Network access technologies may enable wide area coverage for devices, such as client devices with varying degrees of mobility, for example. For example, a network may enable RF or wireless type communication via one or more network access technologies, such as “Global System for Mobile communication” (GSM), “Universal Mobile Telecommunications System” (UMTS), “General Packet Radio Services” (GPRS), “Enhanced Data GSM Environment” (EDGE), 3GPP LTE, LTE Advanced, “Wideband Code Division Multiple Access” (WCDMA), Bluetooth®, 802.11b/g/n, or the like. A wireless network may include virtually any type of wireless communication mechanism by which signals may be communicated between devices, such as a client device or a computing device, between or within a network, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a near field communication (NFC) device, a personal digital assistant (PDA), a handheld computer, a tablet computer, a phablet, a laptop computer, a set top box, a wearable computer, an integrated device combining various features, such as features of the forgoing devices, or the like.

A client device may vary in terms of capabilities or features, and claimed subject matter is intended to cover a wide range of potential variations. A web-enabled fixed or mobile device may include a browser application that is configured to receive and to send web pages, web-based messages, and the like. The browser application may be configured to receive and display graphics, text, multimedia, and the like, employing virtually any conventional web-based language. In some embodiments, one or more services of any of the systems described herein can be hosted/consumed in an HTMLS compatible browser. However, other embodiments can include wrapping the service up in a C # component that embeds the NVDEC decoder i.e. not use a browser control. In some embodiments, the service presents an API supporting zoom to/highlighting, and/or picking return of a selected tag identifier/name.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

The following Table 1 includes some non-limiting commands and functions of any of the embodiments described processed by or on one or more of the architectures and/or computer systems:

TABLE 1

| Command | Description |
|---|---|
| loadcache | Set model to display |
| highlight | Highlight object at screen coordinate |
| mousemove | Mouse moved at screen coordinate |
| mouseup | Mouse up at screen coordinate |
| mousedown | Mouse down at screen coordinate |
| mousescroll | Delta +ve = wheel up, −ve = wheel down |
| rotatestart | x, y = screen coordinate. For pinch interaction this is the |
| | center point between touch points. |
| rotateend | x, y = screen coordinate. For pinch interaction this is the |
| | center point between touch points. |
| Rotatemove | x, y = screen coordinate. For pinch interaction this is the |
| | center point between touch points. |
| | scale < 1.0 = zoom out |
| | scale > 1.0 = zoom in |
| | angle = delta angle in degrees |
| ping | Ping the server |
| outputformat | Start streaming video of specified size. This should be |
| | sent after resizing the browser window. |
| | Format should be MP4_WITH_H.264 when using |
| | MediaSourceExtensions or H.264 for software decoding. |
| | SendHeader should be true by default and false when |
| | transferring connections. |
| identity | Authenticate user with the service. This should be the |
| | first command in any connection to the service. |
| zoomtopid | Zoom to bounding sphere of specified tag or pids |
| setviewpoint | Set camera to specific view point |
| status | Show status of the connected server |
| getviewstate | Get current state of the session |
| setviewstate | Set current state of the session |
| setmaterial | Sets the material (color) to the selected tag |
| getmaterial | Sets the material (color) to the selected tag |
| changevisibility | Change the visibility of the tag like |
| | show/hide/showall/hideall/isolate. |
| getviewpoint | Gets the current viewpoint of the camera (position and |
| | direction) |
| clipping | Sets the clipping style and sets clip planes. |

In some embodiments, the 3D visualization operations management interface 62 can host a web control or a C # component as described above to display the 3D stream, and/or post tag names to the visualization service 125 (“AVS API”) when context changes, and/or respond to picking events to invoke a context change.

In some embodiments of the invention, the flow for the 3D visualization operations management interface 62 can be context-changed including a selection of a selected asset name/path. In some embodiments of the invention, the flow for the 3D visualization operations management interface 62 application can post a call to “ANET” for translation, and get an AVS tag name. In some embodiments of the invention, the flow for the 3D visualization operations management interface 62 application can pass AVS tag name to visualization service 125 zoom to/highlight tag.

In some embodiments, if a user of the operations management interface 62 wants to navigate to another tag in the 3D windows, then the visualization service 125 can pass back a tag name of a selected item to the operations management interface 62 visualization application, and/or call ANET for translation, and get an appropriate alias for selected tag; and/or update operations management interface 62 context. Further, some embodiments include a rule-based translation in some instances.

In some embodiments, any drawings and piping and instrumentation diagrams (e.g., drawings and piping and instrumentation diagram 15) to be viewed (e.g., such as in the display GUI 10) can come from the Application NET data system 55. In some embodiments, a 2D visualization operations management interface 62 application can host a web control viewer to display 2D drawings and piping and instrumentation diagrams, post identifier names to an API of the Application NET data system 55 when context changes, and/or respond to picking events to invoke a context change.

In some embodiments, the flow for the 2D visualization operations management interface 62 application can be context changed to pick up a selected asset name/path, and/or can call Application NET data system 55 for translation, and/or obtain an appropriate alias for selected asset (tag), and/or call an Application NET data system 55 for list of drawings and piping and instrumentation diagrams for a selected asset name/path (e.g., where an asset/tag could have more than one drawings and piping and instrumentation diagram), and/or select drawings and piping and instrumentation diagrams, and/or pass a selected asset (tag) to an API of the Application NET data system 55, and zoom to and/or highlight one or more tags.

In some embodiments, if a user of an OMI wants to navigate to another asset (tag) in the 2D window (e.g., such as an asset represented in the drawings and piping and instrumentation diagram 15 in FIG. 1), then a drawings and piping and instrumentation diagram web control viewer can pass back an asset (tag) name of a selected item to a 2D OMI visualization application of the operations management interface 62. Further, in some embodiments, the system can make a call to an API of the Application NET data system 55 for translation, and get an appropriate alias for selected (asset) tag. Further, the system can call to an API of the Application NET data system 55 for a list of drawings and piping and instrumentation diagrams for a selected asset name/path (an asset/tag could have more than one drawings and piping and instrumentation diagram). Further, some operations can include an update of an operations management interface 62 context, selection of a drawings and piping and instrumentation diagram 15, a passing of a selected asset (tag) to an API of the Application NET data system 55, and a zoom-to/highlight tag operation, and an update operations management interface 62 context.

In some embodiments, a 1D OMI visualization application of the operations management interface 62 can host a web control viewer to display the selected engineering attributes for a given asset (tag), and/or post identifier names to the Application NET data system 55 when context changes, and/or to respond to picking events to invoke a context change i.e., picking events done in a generic OMI visualization application of the operations management interface 62, 3D OMI visualization application of the operations management interface 62, and 2D OMI visualization application of the operations management interface 62.

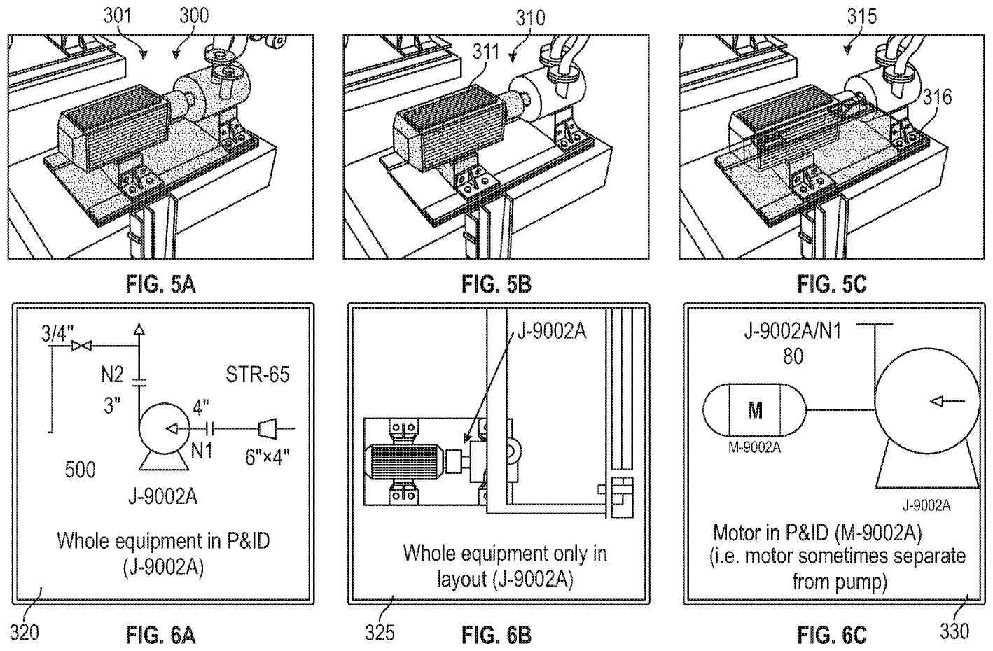

In reference to FIGS. 5A-5C, in some embodiments, the identifiers (tag/asset) can be mapped or aligned between the applications (i.e., between operations management interface 62, Application NET data system 55 and visualization service 125). For example, FIG. 5A shows a whole equipment 301 selected (as equipment identifier “/J-9002A”), FIG. 5B shows motor 311 selected (as sub-equipment identifier “/MOTOR-01”), and FIG. 5C shows a base 316 selected (as sub-equipment “/J-9002A-BASE”). In some embodiments, the visualization service 125 can manage the modelling hierachy as is defined in the 3D model 20. In some embodiments, if an equipment identifier/J-9002A is modelled with sub-equipment/MOTOR-01, /J-9002A-BASE and /MOTOR-01 are selected, the identifier returned will be/MOTOR-01 even if the users interest is in the equipment/J-9002A.

In reference to FIGS. 6A-6C, other embodiments include drawings and piping and instrumentation diagrams, other logic diagrams, layout drawings and lists that have similar tag mapping concerns, where FIGS. 6A-6C illustrate a non-limiting example of logic and/or layout diagrams produced by some embodiments of the invention. For example, FIG. 6A shows a display 320 comprising a drawings and piping and instrumentation diagram of the whole equipment 301 selected (equipment identifier “/J-9002A”) of FIG. 5A. Further, FIG. 6B shows a layout view 325 of the motor 311 selected (sub-equipment identifier “/MOTOR-01”) of FIG. 5B, and FIG. 6C shows a drawings and piping and instrumentation display 330.

In some embodiments, the OMI visualization application of the operations management interface 62, and thus the OMI context can be based on another naming convention including, but not limited to, a path similar to a “Site/Area/Line/Asset”. In some embodiments, this can be translated into a corresponding name which is understood by the visualization service 125.

In some embodiments, the Application NET data system 55 has the capability to store one or more aliases of a tag. In some embodiments, the chosen data set must be updated with appropriate mapping for Application NET data system 55 to be used as a translation service between tag identifiers.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the description and claims herein.

1. A server system comprising:
at least one processor configured to be coupled to a non-transitory computer-readable storage medium, the non-transitory computer-readable storage medium tangibly storing thereon a program logic for execution by the at least one processor, the program logic comprising:
at least one logic module executable by the at least one processor to manage a bi-directional exchange of context-driven data between application objects of the program logic and one or more distributed assets of a distributed environment;
at least one display controller coupled to the at least one logic module, the at least one display controller configured to render at least one operations management interface on at least one user display, the at least one operations management interface configured to display at least one distributed asset of a distributed environment with at least one attribute of the at least one distributed asset; and
at least one navigation module executable by the at least one processor configured for varying a displayed context of at least one virtual representation of at least a portion of the at least one distributed asset based at least in part on at least one of input from at least one user and at least a portion of the context-driven data.

2. The server system of claim 1, wherein the one or more distributed assets include one or more distributed components of a process control and/or manufacturing information system of the distributed environment.

3. The server system of claim 2, wherein the at least one display controller includes controls for graphically manipulating displays of virtual representations of at least one or more distributed components of the at least one distributed asset, wherein a displayed context of at least one of the one or more distributed components is altered based at least in part on at least one of at least one user selection of at least one distributed asset and a context relationship of at least one component of the at least one distributed asset to at least one other component of the at least one distributed asset.

4. The server system of claim 1, wherein the displayed context corresponds to the at least one attribute of at least one distributed component.

5. The server system of claim 1, wherein the at least one attribute includes an operational status of at least one component of the at least one distributed asset.

6. The server system of claim 1, wherein the at least one attribute includes an alarm status of at least one component of the at least one distributed asset.

7. The server system of claim 1, wherein the at least one attribute includes data derived from at least one of a maintenance record, an equipment data specification, a drawings and piping and instrumentation diagram, and a standard operating procedure of at least one component of the at least one distributed asset.

8. The server system of claim 1, wherein the at least one operations management interface is further configured to display a substantially real-time visualization of operational data of at least one component of the at least one distributed asset.

9. The server system of claim 1, wherein the at least one navigation module is executable by the at least one processor to enable the at least one user to navigate either an operational model or an engineering model, wherein the display adjusts automatically to a changing context of at least one asset of the one or more distributed assets, and displays appropriate contextual information.

10. The server system of claim 1, wherein the at least one operations management interface is further configured to display at least one process graphic associated with one or more alarms related to at least one component of the at least one distributed asset.

11. The server system of claim 1, wherein the at least one virtual representation of at least a portion of the at least one distributed asset includes one or more 3D models of at least a portion of an industrial facility of process.

12. The server system of claim 11, wherein the at least one navigation module executable by the at least one processor is configured to enable the at least one user to zoom-in to one or more 3D models, and display selectable drawings and piping and instrumentation diagram context or data sheets related to a visualized asset.

13. The server system of claim 12, wherein the at least one navigation module is configured to dynamically react to context change during any zoom-in or zoom-out commands or actions, and is further configured to show appropriate process graphics and/or alarms based at least in part on an updated context of the at least one virtual representation.

14. A server system comprising:
program logic tangibly stored on at least one non-transitory computer-readable storage medium;
at least one processor coupled to the non-transitory computer-readable storage medium, wherein upon execution of at least a portion of the program logic by the at least one processor, the at least one processor is configured to process a method including:
operating at least one display controller configured to render at least one operations management interface on at least one user display, the at least one operations management interface configured to display at least one distributed asset of a distributed environment including a display of at least one attribute of the at least one distributed asset;
operating at least one navigation module executable by the at least one processor for varying a displayed context of the at least one virtual representation of at least a portion of the at least one distributed asset; and
displaying controls for graphically manipulating at least a portion of the at least one virtual representation, wherein a displayed context of at least one component of the one or more distributed assets is dynamically variable based at least in part on at least one of at least one user selection of at least one distributed asset and a context relationship of the at least one component of the at least one distributed asset in relation to at least one other component of the at least one distributed asset.

15. The server system of claim 14, wherein the at least one attribute includes at least one of an operational status of at least one component of the at least one distributed asset, and an alarm status of at least one component of the at least one distributed asset.

16. The server system of claim 14, wherein at least a portion of the program logic includes a mapping component configured to be executed by the at least one processor to display map components and location data of the at least one distributed asset.

17. The server system of claim 14, wherein the at least one attribute includes data derived from at least one of a maintenance record, an equipment data specification, a drawings and piping and instrumentation diagram, and a standard operating procedure of at least one component of the at least one distributed asset.

18. The server system of claim 14, wherein the at least one operations management interface is further configured to display a substantially real-time visualization of operational data of at least one component of the at least one distributed asset.

19. The server system of claim 14, wherein the method further includes enabling the at least one user to zoom-in to one or more 3D models rendered by the at least one operations management interface, and display selectable drawings and piping and instrumentation diagram context or data sheets related to a visualized asset.

20. The server system of claim 14, wherein the at least one operations management interface is further configured to display at least one process graphic associated with one or more alarms related to at least one component of the at least one distributed asset.
